(19) United States
(12) Patent Application Publication
(10) Pub. No.: US 2022/0234545 A1
(43) Pub. Date: Jul. 28, 2022

(54) ROTATING BLADE MECHANISM FOR CLEANING CYLINDRICAL SENSORS

(71) Applicant: GM Cruise Holdings LLC, SAN FRANCISCO, CA (US)

(72) Inventors: Nathaniel Herse, San Francisco, CA (US); Michael Shagam, San Francisco, CA (US); Isaac Brown, San Francisco, CA (US); Wesley Newhouse, San Francisco, CA (US)

(21) Appl. No.: 17/722,180

(22) Filed: Apr. 15, 2022

Related U.S. Application Data
(63) Continuation-in-part of application No. 16/992,268, filed on Aug. 13, 2020.

(51) Int. Cl. B60S 1/52; B08B 5/02; B08B 3/02; B08B 13/00; G01S 17/931; B60W 60/00; B60S 1/54

(52) U.S. Cl. CPC B60S 1/52; B08B 5/02; B08B 3/024; B08B 1/005; G01S 17/931; B60W 60/00; B60S 1/54; B08B 13/00

(57) ABSTRACT

Systems, methods, and computer-readable media are provided for implementing a self-cleaning sensor apparatus. In some examples, the self-cleaning sensor apparatus can include an optical sensor; an actuator system to rotate a rotary joint of the self-cleaning sensor apparatus; a manifold directly or indirectly coupled to the rotary joint, the manifold being configured to rotate in response to a rotation of the rotary joint, and wherein the manifold is disposed at an angle relative to a top or bottom surface of the optical sensor; and one or more nozzles disposed within the manifold, the one or more nozzles being configured to spray compressed air on an exterior surface of the optical sensor, the exterior surface including a surface of a lens of the optical sensor and/or a surface configured to send and receive optical signals associated with the optical sensor.

### CROSS-REFERENCE TO RELATED APPLICATIONS

This application is a continuation-in-part (CIP) of U.S. Non-Provisional patent application Ser. No. 16/992,268, entitled “ROTATING BLADE MECHANISM FOR CLEANING CYLINDRICAL SENSORS”, filed on Aug. 13, 2020, the contents of which are incorporated herein by reference in their entirety and for all purposes.

### BACKGROUND

### 1. Technical Field

The present disclosure generally relates to sensor implementations for autonomous vehicles and, more specifically, cleaning sensors and maintaining a performance of sensors implemented by autonomous vehicles (AVs).

### 2. Introduction

An autonomous vehicle is a motorized vehicle that can navigate without a human driver. An exemplary autonomous vehicle can include various sensors, such as a camera sensor, a light detection and ranging (LIDAR) sensor, and a radio detection and ranging (RADAR) sensor, amongst others. The sensors collect data and measurements that the autonomous vehicle can use for operations such as navigation. The sensors can provide the data and measurements to an internal computing system of the autonomous vehicle, which can use the data and measurements to control a mechanical system of the autonomous vehicle, such as a vehicle propulsion system, a braking system, or a steering system. Typically, the sensors are mounted at fixed locations on the autonomous vehicles.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 illustrates an example system environment that can be used to facilitate AV navigation and routing operations, according to some examples of the present disclosure;

FIG. 2 illustrates an example of an autonomous vehicle (AV) environment in which a sensor cleaning apparatus of the disclosed technology can be implemented, according to some examples of the present disclosure;

FIG. 3 illustrates an example self-cleaning sensor, according to some examples of the present disclosure;

FIG. 4A illustrates an example process for constructing a self-cleaning sensor, according to some examples of the present disclosure;

FIG. 4B illustrates an example process for initiating a sensor operation, according to some examples of the present disclosure;

FIG. 5 is a diagram illustrating an example of a self-cleaning sensor apparatus, according to some examples of the present disclosure;

FIG. 6A is a diagram illustrating an example path of air emitted by nozzles in a manifold of a self-cleaning sensor apparatus, according to some examples of the present disclosure;

FIG. 6B is a diagram illustrating an example view of a drive system and parking brake of an example self-cleaning sensor apparatus, according to some examples of the present disclosure;

FIG. 7 is a diagram illustrating an example pneumatic motor that can provide an alternative spinning drive for a self-cleaning sensor apparatus, according to some examples of the present disclosure;

FIG. 8A is a flowchart illustrating an example process for constructing a self-cleaning apparatus, according to some examples of the present disclosure;

FIG. 8B is a flowchart illustrating an example process for using a self-cleaning apparatus, according to some examples of the present disclosure; and

FIG. 9 illustrates an example processor-based system with which some aspects of the subject technology can be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

One aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

As previously explained, autonomous vehicles (AVs) can include various sensors, such as a camera sensor, a light detection and ranging (LIDAR) sensor, a radio detection and ranging (RADAR) sensor, amongst others, which the AVs can use to collect data and measurements that the AVs can use for operations such as navigation. The sensors can provide the data and measurements to an internal computing system of the autonomous vehicle, which can use the data and measurements to control a mechanical system of the autonomous vehicle, such as a vehicle propulsion system, a braking system, or a steering system.

The AVs are often used in a variety of environments and under various weather conditions. The environments and weather conditions can cause the sensors implemented by the AVs to accumulate particles (e.g., debris, fluids, dirt, dust, and/or other particles), which can negatively impact the field-of-view (FOV) and/or visibility of the sensors. For example, the sensors of the AV can collect various particles from the surrounding environment. When the area(s) of a sensor configured to receive light or other types of signals collects particles, the particles can obstruct a FOV and/or visibility of the sensor, and thus limit what the sensor can “see” or detect. This can in turn affect the performance of the AV implementing such sensor, as it can reduce what the AV can detect in the surrounding environment. However, AVs need to have a robust understanding of their environment to operate, and because they largely rely on sensors to navigate and understand their environment, a sensor blind spot, reduced FOV, and/or reduced performance can create numerous impediments or limitations to the operation of the AVs.

Moreover, the cleaning of optical surfaces on sensors can pose many challenges. For example, fixed nozzle cleaning requires nozzles with high flow rates and/or pressures as various sensors, such as cylindrical sensors (e.g., cylindrical LiDAR sensors, etc.) often have a large optical surface with a wide FOV. In addition, cylindrical sensors can sense in all directions, which can require numerous high flow nozzles to provide full, unobstructed cleaning coverage. As a result, the corresponding systems that provide compressed air and/or liquid (e.g., via nozzles) typically have large pressure and flow rate requirements, which can make the sensor cleaning systems large, expensive, and complex due to the increased size of the air compressor, the air tank, the air lines, the fittings, any other components associated with the systems that provide compressed air and/or liquid, and/or any combination thereof.

Conventional wiper blade solutions are not ideal for AV sensor implementations. For example, wiper blade solutions can cause excessive wear on optical surfaces and thus compromise sensor performance. Wiper blades also have poor service life and reliability. Moreover, linear/oscillating wipers do not work well on cylindrical surfaces. A straight (e.g., parallel to the cylinder axis) rotating wiper blade does not remove debris and can instead smear the debris around the optical surface, resulting in poor sensor performance.

Aspects of the disclosed technologies address the foregoing limitations by providing a rotating (e.g., non-contacting) blade configured to clean the cylindrical surfaces of various sensors. The rotating blade can include one or more integrated nozzles configured to output air and/or a solution (e.g., water and/or any fluid or cleaning solution) for cleaning the cylindrical surfaces of the sensors. Because the wiper blade does not contact the sensor's optical surface, the wiper blade can avoid smearing debris on the sensor's optical surface and possible scratching the delicate optical surface of the sensor. In some examples, the rotation of the wiper blade that contains the one or more nozzles can reduce the necessary nozzle count by scanning a nozzle (or an integrated nozzle array) over a larger surface area of the sensor. Moreover, the close proximity between the one or more nozzles and the optical surface can reduce flow and/or pressure demands, thereby improving cleaning efficacy and reducing the cost, size, and/or complexity of the sensor cleaning system.

Although the sensor cleaning systems and methods discussed herein make reference to cylindrical sensors operated in an AV context, it is understood that other implementations are contemplated. For example, cylindrical sensors and the cleaning systems and methods disclosed herein may be deployed on non-autonomous vehicles, on vehicles of other types (e.g., aircraft, watercraft, an unmanned aerial vehicle, etc.), and/or in virtually any other context, without departing from the scope of the disclosed technology. As such, the disclosed examples are understood to be illustrative of some embodiments of the disclosed technology, but do not represent the only modes in which the technology may be practiced.

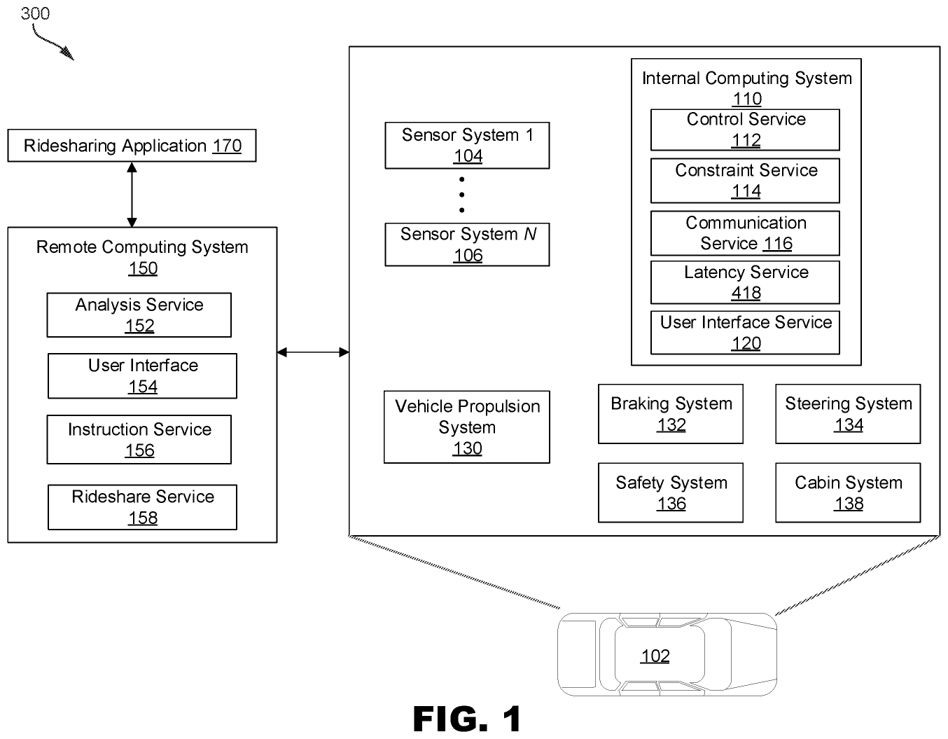

FIG. 1 illustrates an example autonomous vehicle environment 100, according to some examples of the present technology. The example autonomous vehicle environment 100 includes an autonomous vehicle 102, a remote computing system 150, and a ridesharing application 170. The autonomous vehicle 102, remote computing system 150, and ridesharing application 170 can communicate with each other over one or more networks, such as a public network (e.g., a public cloud, the Internet, etc.), a private network (e.g., a local area network, a private cloud, a virtual private network, etc.), and/or a hybrid network (e.g., a multi-cloud or hybrid cloud network, etc.).

The autonomous vehicle 102 can navigate about roadways without a human driver based on sensor signals generated by sensor systems 104-106 on the autonomous vehicle 102. The sensor systems 104-106 on the autonomous vehicle 102 can include one or more types of sensors and can be arranged about the autonomous vehicle 102. For example, the sensor systems 104-106 can include, without limitation, one or more inertial measuring units (IMUs), one or more image sensors (e.g., visible light image sensors, infrared image sensors, video camera sensors, surround view camera sensors, etc.), one or more light emitting sensors, one or more light detection and ranging sensors (LIDARs), one or more radio detection and ranging (RADAR) sensor systems, one or more electromagnetic detection and ranging (EmDAR) sensor systems, one or more sound navigation and ranging (SONAR) sensor systems, one or more sound detection and ranging (SODAR) sensor systems, one or more global navigation satellite system (GNSS) receiver systems such as global positioning system (GPS) receiver systems, one or more accelerometers, one or more gyroscopes, one or more infrared sensor systems, one or more laser rangefinder systems, one or more ultrasonic sensor systems, one or more infrasonic sensor systems, one or more microphones, or any combination thereof. For example, in some implementations, sensor system 104 can be a RADAR or LIDAR, and sensor system 106 can be an image sensor. Other implementations can include any other number and type of sensors.

The autonomous vehicle 102 can include several mechanical systems that are used to effectuate motion of the autonomous vehicle 102. For instance, the mechanical systems can include, but are not limited to, a vehicle propulsion system 130, a braking system 132, and a steering system 134. The vehicle propulsion system 130 can include an electric motor, an internal combustion engine, or both. The braking system 132 can include an engine brake, brake pads, actuators, and/or any other suitable componentry configured to assist in decelerating the autonomous vehicle 102. The steering system 134 includes suitable componentry configured to control the direction of movement of the autonomous vehicle 102 during navigation.

The autonomous vehicle 102 can include a safety system 136. The safety system 136 can include lights and signal indicators, a parking brake, airbags, etc. The autonomous vehicle 102 can also include a cabin system 138, which can include cabin temperature control systems, in-cabin entertainment systems, etc.

The autonomous vehicle 102 can include an internal computing system 110 in communication with the sensor systems 104-106 and the systems 130, 132, 134, 136, and 138. The internal computing system 110 includes one or more processors and at least one memory for storing instructions executable by the one or more processors. The computer-executable instructions can make up one or more services for controlling the autonomous vehicle 102, communicating with remote computing system 150, receiving inputs from passengers or human co-pilots, logging metrics regarding data collected by sensor systems 104-106 and human co-pilots, etc.

The internal computing system 110 can include a control service 112 configured to control operation of the vehicle propulsion system 130, the braking system 132, the steering system 134, the safety system 136, and the cabin system 138. The control service 112 can receive sensor signals from the sensor systems 104-106 can communicate with other services of the internal computing system 110 to effectuate operation of the autonomous vehicle 102. In some examples, control service 112 may carry out operations in concert with one or more other systems of autonomous vehicle 102.

The internal computing system 110 can also include a constraint service 114 to facilitate safe propulsion of the autonomous vehicle 102. The constraint service 114 includes instructions for activating a constraint based on a rule-based restriction upon operation of the autonomous vehicle 102. For example, the constraint may be a restriction on navigation that is activated in accordance with protocols configured to avoid occupying the same space as other objects, abide by traffic laws, circumvent avoidance areas, etc. In some examples, the constraint service 114 can be part of the control service 112.

The internal computing system 110 can also include a communication service 116. The communication service 116 can include software and/or hardware elements for transmitting and receiving signals to and from the remote computing system 150. The communication service 116 can be configured to transmit information wirelessly over a network, for example, through an antenna array or interface that provides cellular (long-term evolution (LTE), 3rd Generation (3G), 5th Generation (5G), etc.) communication.

In some examples, one or more services of the internal computing system 110 are configured to send and receive communications to remote computing system 150 for reporting data for training and evaluating machine learning algorithms, requesting assistance from remote computing system 150 or a human operator via remote computing system 150, software service updates, ridesharing pickup and drop off instructions, etc.

The internal computing system 110 can also include a latency service 118. The latency service 118 can utilize timestamps on communications to and from the remote computing system 150 to determine if a communication has been received from the remote computing system 150 in time to be useful. For example, when a service of the internal computing system 110 requests feedback from remote computing system 150 on a time-sensitive process, the latency service 118 can determine if a response was timely received from remote computing system 150, as information can quickly become too stale to be actionable. When the latency service 118 determines that a response has not been received within a threshold period of time, the latency service 118 can enable other systems of autonomous vehicle 102 or a passenger to make decisions or provide needed feedback.

The internal computing system 110 can also include a user interface service 120 that can communicate with cabin system 138 to provide information or receive information to a human co-pilot or passenger. In some examples, a human co-pilot or passenger can be asked or requested to evaluate and override a constraint from constraint service 114. In other examples, the human co-pilot or passenger may wish to provide an instruction to the autonomous vehicle 102 regarding destinations, requested routes, or other requested operations.

As described above, the remote computing system 150 can be configured to send and receive signals to and from the autonomous vehicle 102. The signals can include, for example and without limitation, data reported for training and evaluating services such as machine learning services, data for requesting assistance from remote computing system 150 or a human operator, software service updates, rideshare pickup and drop off instructions, etc.

The remote computing system 150 can include an analysis service 152 configured to receive data from autonomous vehicle 102 and analyze the data to train or evaluate machine learning algorithms for operating the autonomous vehicle 102. The analysis service 152 can also perform analysis pertaining to data associated with one or more errors or constraints reported by autonomous vehicle 102.

The remote computing system 150 can also include a user interface service 154 configured to present metrics, video, images, sounds reported from the autonomous vehicle 102 to an operator of remote computing system 150, maps, routes, navigation data, notifications, user data, vehicle data, software data, and/or any other content. User interface service 154 can receive, from an operator, input instructions for the autonomous vehicle 102.

The remote computing system 150 can also include an instruction service 156 for sending instructions regarding the operation of the autonomous vehicle 102. For example, in response to an output of the analysis service 152 or user interface service 154, instruction service 156 can prepare instructions to one or more services of the autonomous vehicle 102 or a co-pilot or passenger of the autonomous vehicle 102.

The remote computing system 150 can also include a rideshare service 158 configured to interact with ridesharing applications 170 operating on computing devices, such as tablet computers, laptop computers, smartphones, head-mounted displays (HMDs), gaming systems, servers, smart devices, smart wearables, and/or any other computing devices. In some cases, such computing devices can be passenger computing devices. The rideshare service 158 can receive from passenger ridesharing application 170 requests, such as user requests to be picked up or dropped off, and can dispatch autonomous vehicle 102 for a requested trip.

The rideshare service 158 can also act as an intermediary between the ridesharing application 170 and the autonomous vehicle 102. For example, rideshare service 158 can receive from a passenger instructions for the autonomous vehicle 102, such as instructions to go around an obstacle, change routes, honk the horn, etc. The rideshare service 158 can provide such instructions to the autonomous vehicle 102 as requested.

The remote computing system 150 can also include a package service 162 configured to interact with the ridesharing application 170 and/or a delivery service 172 of the ridesharing application 170. A user operating ridesharing application 170 can interact with the delivery service 172 to specify information regarding a package to be delivered using the autonomous vehicle 102. The specified information can include, for example and without limitation, package dimensions, a package weight, a destination address, delivery instructions (e.g., a delivery time, a delivery note, a delivery constraint, etc.), and so forth.

The package service 162 can interact with the delivery service 172 to provide a package identifier to the user for package labeling and tracking. Package delivery service 172 can also inform a user of where to bring their labeled package for drop off. In some examples, a user can request the autonomous vehicle 102 come to a specific location, such as the user's location, to pick up the package. While delivery service 172 has been shown as part of the ridesharing application 170, it will be appreciated by those of ordinary skill in the art that delivery service 172 can be its own separate application.

One example beneficial aspect of utilizing autonomous vehicle 102 for both ridesharing and package delivery is increased utilization of the autonomous vehicle 102. Instruction service 156 can continuously keep the autonomous vehicle 102 engaged in a productive itinerary between rideshare trips by filling what otherwise would have been idle time with productive package delivery trips.

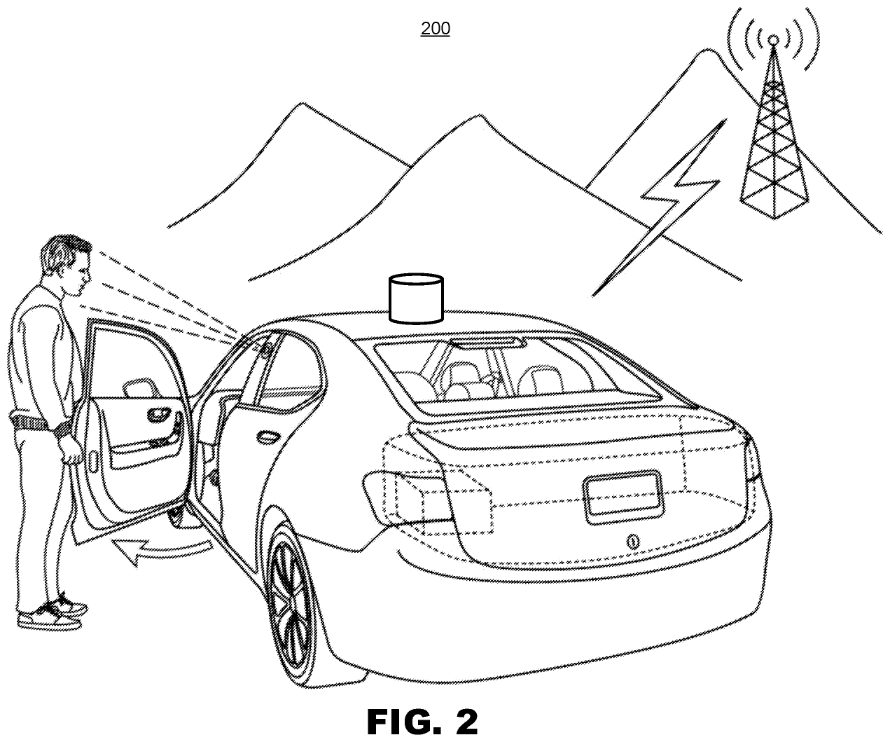

FIG. 2 illustrates an example of an autonomous vehicle (AV) environment 200 in which a sensor cleaning apparatus of the disclosed technology can be implemented. The environment 200 includes AV 202. The AV 202 can use a cylindrical sensor 206. Data collected by the sensor 206 during operation of the AV 202 can be processed by compute unit 204, for example, to enable navigation and routing functions for the AV 102 that are used provide a ride service to one or more users/riders, e.g., rider 210. In some aspects, navigation and routing functions can also be facilitated through signals provided by one or more remote systems (e.g., a dispatch system) using a wireless communication channel, for example, provided by a wireless access point 208.

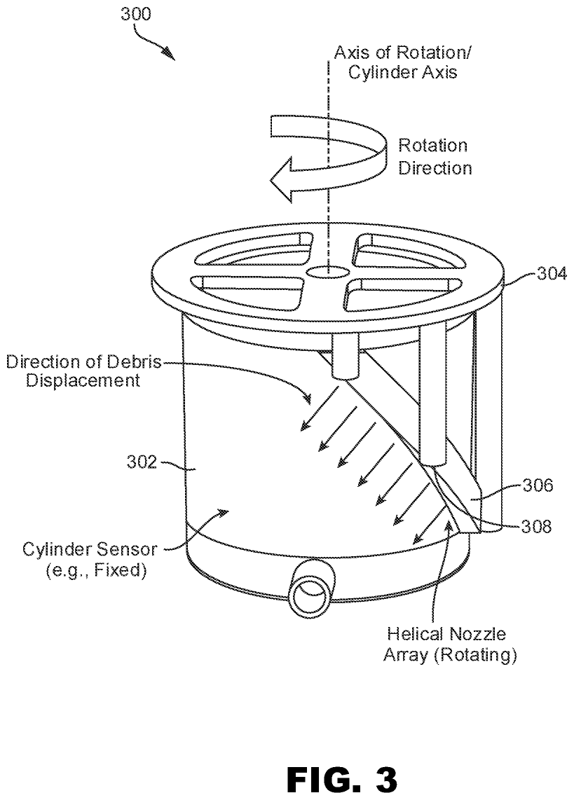

In operation, the sensor 206 can be an optical sensor, such as a Light Detection and Ranging (LiDAR) sensor, that is configured to transmit and receive light through an optical surface. During operation of the sensor 206, the optical surface may become occluded, for example, due to the settling of dust, dirt, moisture, and/or other debris that can impede the transmission of light. In some aspects, a self-cleaning sensor system of the disclosed technology can be deployed to clean/maintain the optical sensor. Depending on the desired implementation, sensor cleaning may be performed continuously, periodically, or at discrete times, for example, in response to specific indications that the sensor's optical surface needs cleaning. Further details regarding the mechanical operation of a self-cleaning system are provided with respect to FIG. 3.

In particular, FIG. 3 illustrates an example self-cleaning sensor 300, according to some examples of the present disclosure. Sensor 300 includes a cylindrical sensor 302 (e.g., a LiDAR sensor, etc.), a wiper housing 304, and a wiper blade 306. As illustrated in the example of FIG. 3, the wiper assembly includes a wiper blade 306 that is affixed to the housing 304 such that the blade 306 is positioned in a downward angle with respect to a top-surface of the cylindrical sensor 302. As illustrated, the housing 304 can be affixed to a top-surface of the sensor 302, for example, so that the attachment point does not occlude an optical surface of the sensor 302. Although the example illustrated in FIG. 3 depicts a self-cleaning sensor 300 with a single blade (e.g., wiper blade 306), it is understood that two or more blades may be implemented, without departing from the scope of the disclosed technology.

In operation, the housing 304 is configured to rotate so that the blade 306 is scanned over an optical surface of the sensor 302. Depending on the desired implementation, the blade 306 can be configured to contact the optical surface of the sensor 302 or configured rotate about the optical surface, without physical contact. Because the sensor 302 may implement a light scanning operation, the angular speed of the wiper blade 306 can be configured based on the sensor's scanning rate so that the wiper blade 306 does not obstruct sensor operation. By way of example, the sensor 302 can be a LiDAR sensor with a scanning rate of approximately 10 Hz. As such, the wiper assembly, i.e., wiper housing 304 and wiper blade 306, can also rotate about the optical sensor 302 at a frequency of approximately 10 Hz. By matching the rotational frequency while placing the wiper blade 306 away from the path of the underlying scanning lasers (e.g., out of phase), sensor cleaning can be performed without interfering with operation of the sensor 302. Depending on the desired implementation, ensuring that the wiper 306 does not obstruct sensor operation can be performed in different ways. For example, the housing 304 may be affixed to the same driver/motor that controls the laser scanning of the LiDAR sensor, for example, such that the rotational speeds are matched. Alternatively, the housing 304 may be controlled by a separate motor that is calibrated to match the scanning rate of the sensor 302. It is understood that different scanning rates for the sensor and/or the wiper blade 306 may be used, without departing from the scope of the disclosed technology.

In some implementation, scanning of the wiper blade 306 may not be continuous. In such approaches, the wiper blade 306, when stationary can be positioned in an unused field of view (FOV) region of an optical surface of the sensor 302. By way of example, placement of the sensor 302 may be such that only a fraction of the radial view angle (e.g., 250 degrees) is used for scanning. As such, the wiper blade 306 can be parked in the unused portion of the FOV of the sensor 302.

Removal of dirt, moisture and/or other debris, etc., from an optical surface of the sensor 302 is facilitated by the use of one or more nozzles 308 that are disposed within the wiper blade 306. In some approaches, the nozzles 308 are configured to apply compressed gas (e.g., air) to the optical surface. Because the nozzles are arranged in a helical array that points in a downward direction relative to the top surface of the sensor 302, debris is pushed down without smearing the optical surface. Additionally, by placing the nozzles 308 in close proximity to, but without contact with, the optical surface, the flow rate of the compressed gas can be reduced as opposed to cleaning nozzles that are disposed at a greater distance. Additionally, by rotating/scanning the nozzles 308 around the optical surface via rotation of wiper blade 306, fewer nozzles may be implemented for example, relative to fixed-array implementations, while still providing an effective sensor cleaning solution.

In other aspects, the nozzles 308 can be configured to apply a liquid cleaning agent, such as water or a solvent-based cleaning fluid (e.g., ethanol or methanol, etc.), to a surface of the optical sensor. Additionally, in some implementations, the leading edge of the wiper blade 306 may be configured to contact the optical surface of the sensor, thereby providing mechanical force to facilitate the clearance of debris.

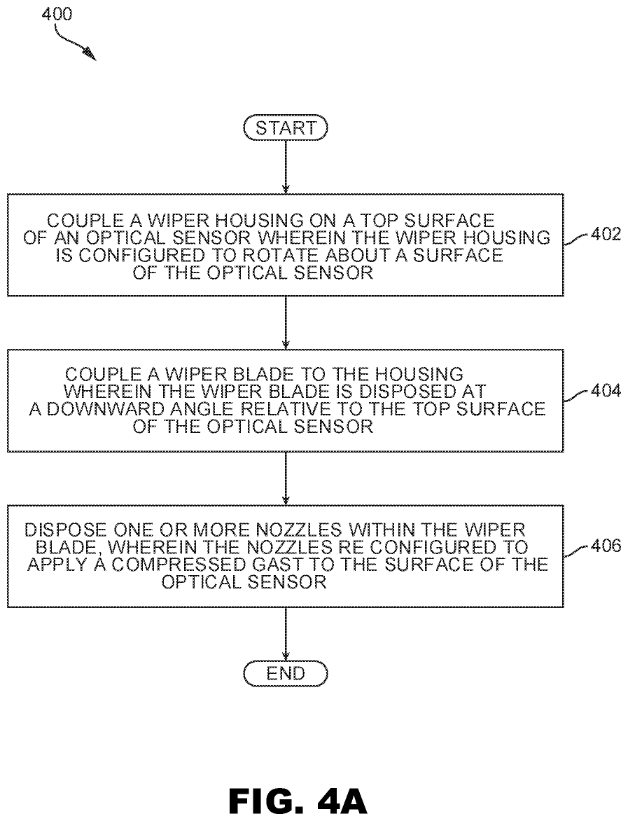

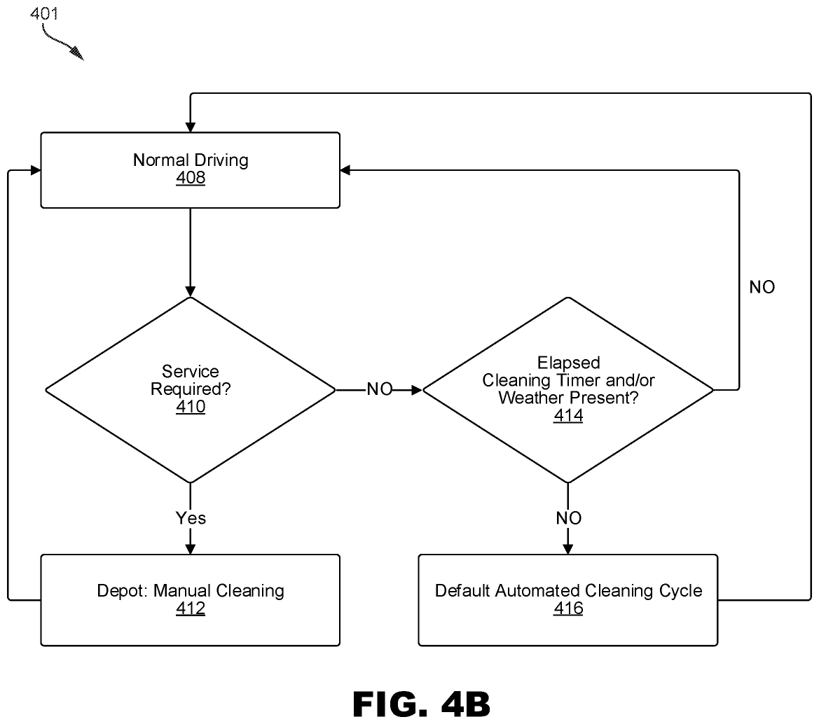

FIG. 4A illustrates an example process 400 for constructing a self-cleaning sensor, according to some examples of the present disclosure. Process 400 begins with block 402 in which a cleaning apparatus housing (wiper housing) is coupled to a cylindrical sensor. In some aspects, the cylindrical sensor may be an optical sensor, such as a LiDAR sensor. However, other types of cylindrical sensors are contemplated, without departing from the scope of the disclosed technology.

Coupling between the cleaning apparatus housing and the cylindrical sensor can be based on the sensor design. For example, the wiper housing may be affixed to a top surface of the cylindrical sensor, or a bottom surface, depending on the desired implementation. Once coupled to the cylindrical sensor, the wiper housing is configured to be rotated about a surface (e.g., an optical surface) of the cylindrical sensor. As discussed above, rotation of the housing may be controlled by the same motor/driver that controls laser scanning of the cylindrical sensor, for example, in LiDAR implementations.

At block 404, a wiper blade is coupled to the housing. As discussed above with respect to FIG. 3, the wiper blade can be configured to be disposed at a downward angle relative to a top-surface of the cylindrical sensor/sensor housing. As such, a leading edge of the wiper blade, when rotated, is designed to push in a downward direction with respect to the optical surface of the cylindrical sensor.

At block 406, one or more nozzles are disposed within the wiper blade. Further to the example illustrated in FIG. 3, the nozzles can be fixed in a helical arrangement. In some aspects, the nozzles can be configured to apply compressed gas to a surface (e.g., an optical surface) of the cylindrical sensor. In other implementations, the nozzles may be configured to apply a liquid, such as water or another cleaning agent. It is understood that different numbers of nozzles may be implemented in the wiper blade, without departing from the scope of the disclosed technology.

FIG. 4B illustrates an example process 401 for initiating an AV sensor cleaning operation, according to some examples of the present disclosure. Process 401 begins at block 408, in which normal AV driving is commenced. Next, at block 410, it is determined whether AV service is required. If AV service is required, process 401 advances to block 412, and sensor cleaning is performed, for example, in conjunction with the needed AV servicing. For example, sensor cleaning may be performed manually at a depot, e.g., as part of routine AV maintenance. Alternatively, if no service is required at block 410, process 401 advances to block 414 in which it is determined if a time value associated with the cleaning timer has elapsed and/or if inclement weather is present. In some implementations, sensor cleaning may be performed at pre-determined time intervals counted by the cleaning timer. As such, sensor cleaning can be performed at regular intervals, based on the cleaning timer configuration. In such approaches, process 401 advances to block 416 and sensor cleaning is performed. Process 401 then reverts back to block 408 in which normal driving is commenced.

If at block 414 it is determined that inclement weather is present, for example, in which the sensor/s may be exposed to dirt, debris, and/or moisture that could affect operation, then process 401 proceeds to block 416 and sensor cleaning is performed. Depending on the desired implementation, weather or sensor debris may be detected using one or more of the AV's environmental sensors, or may be identified using data received from a remote source, such as a third-party weather reporting service.

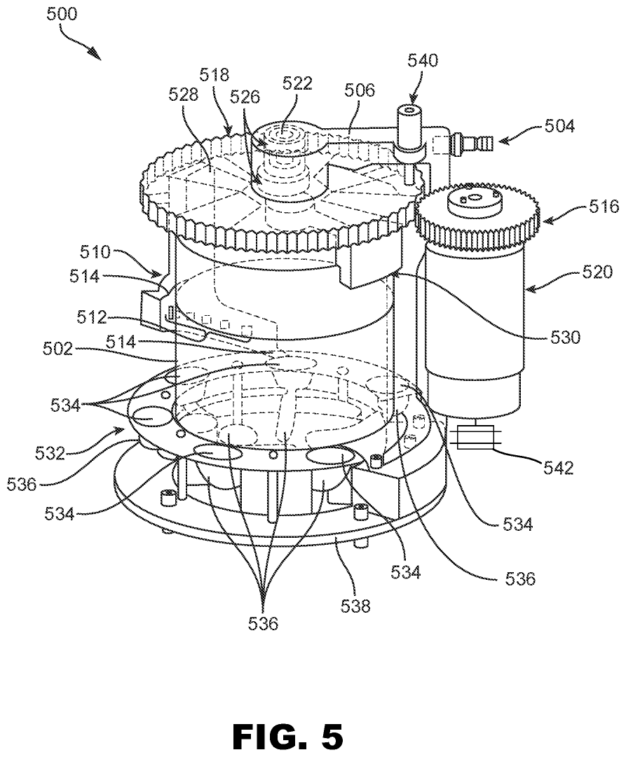

FIG. 5 is a diagram illustrating another example of a self-cleaning sensor apparatus 500, according to some examples of the present disclosure. The self-cleaning sensor apparatus 500 can include a cylindrical sensor 502. The cylindrical sensor 502 can include an optical sensor such as, for example, a LIDAR sensor or an image sensor. In some examples, the cylindrical sensor 502 and/or sensing elements of the cylindrical sensor 502 can rotate about a fixed axis of the cylindrical sensor 502 to increase the FOV and/or coverage of the cylindrical sensor 502.

For example, the cylindrical sensor 502 (and/or sensing elements of the cylindrical sensor 502) can rotate at a specific rate to increase the coverage or visibility of the cylindrical sensor 502. The cylindrical sensor 502 can include one or more optical transmitters and receivers that the cylindrical sensor 502 can use to scan an environment as the cylindrical sensor 502 rotates in order to detect objects in the environment and/or characteristics of the environment. In some examples, the cylindrical sensor 502 can include an array of optical transmitters and receivers, such as an array of laser transmitters and receivers, which can scan an environment. In such examples, as the cylindrical sensor 502 rotates, the array of optical transmitters and receivers can rotate with the cylindrical sensor 502 and scan the environment as they rotate.

The placement or position of the array of optical transmitters and receivers on the cylindrical sensor 502 can vary in different implementations. For example, in some cases, the array of optical transmitters and receivers can be aligned along a vertical axis of the cylindrical sensor 502. As the cylindrical sensor 502 rotates, the array of optical transmitters and receivers along the vertical axis can rotate and scan the environment. In other cases, the array of optical transmitters and receivers can be aligned in any other manner and/or positioned anywhere in the cylindrical sensor 502.

Thus, the AV 102 can use the cylindrical sensor 502 to collect data and/or measurements in a surrounding environment. The AV 102 can use the collected data and/or measurements to assist with AV operations such as, for example, navigation and routing operations. Moreover, the AV 102 can implement the self-cleaning sensor apparatus 500 to clean the cylindrical sensor 502 as needed. The cleaning of the cylindrical sensor 502 can increase the performance of the cylindrical sensor 502 and the quality of the data captured by the cylindrical sensor 502.

As previously explained, optical sensors, such as the cylindrical sensor 502, used by AVs are typically exposed to the elements and may need to be kept clean for optimal performance and perception. In some cases, dust, dirt, debris, rain, and/or other particles can be cleaned or cleared from an optical sensor by spraying air, fluid, and/or mechanical wiping around the surface of the optical sensor or the optical sensor's lens. However, when the optical sensor is sprayed with a fluid, the fluid can leave droplets on the lens of the optical sensor, which can be detrimental to the optical sensor's performance. A same or similar condition can occur when the AV implementing the optical sensor drives in the rain or any form of precipitation. However, in both scenarios, the self-cleaning sensor apparatus 500 described herein can clear any precipitation, such as liquid droplets, from the surface and/or lens of the cylindrical sensor 502, and can remove any dirt, dust, debris, and/or any other particles from the surface and/or lens of the cylindrical sensor 502.

Moreover, the self-cleaning sensor apparatus 500 can clear liquid droplets and other particles more effectively than static nozzles above or below the lens of the cylindrical sensor 502, and can do so more efficiently (e.g., quicker, using less compressed air and/or cleaning fluid, etc.) at least partly because of the reduced distance from one or more nozzles 512 of the self-cleaning sensor apparatus 500 to the lens of the cylindrical sensor 502. In some examples, the self-cleaning sensor apparatus 500 can reduce the amount of compressed air used and/or needed to clean the surface of the lens of the cylindrical sensor 502. By using less compressed air, the self-cleaning sensor apparatus 500 can be implemented with a smaller air compressor which can result in less battery energy of the AV 102 being used to clean the cylindrical sensor 502. The reduced battery energy used by the self-cleaning sensor apparatus 500 can result in an increase in the battery range of the AV 102. Similarly, in implementations of the self-cleaning sensor apparatus 500 in gas-powered vehicles, the reduced energy used by the self-cleaning sensor apparatus 500 can result in less energy consumption (e.g., to power the air compressor) for the gas-powered vehicles and an increase in energy available for propulsion and/or other operations of the gas-powered vehicles.

As shown in FIG. 5, the self-cleaning sensor apparatus 500 can include an inlet 504 for receiving compressed air, which the self-cleaning sensor apparatus 500 can use to remove moisture, dirt, dust, debris, droplets, particles, etc., on the cylindrical sensor 502, as further explained herein. In some examples, the inlet 504 can include an adapter, connector, or fitting configured to connect to an air hose or tubing to receive the compressed air. In other examples, the inlet 504 can include an opening for receiving at least a portion of the air hose or tubing.

In some cases, the inlet 504 can include an adapter, connector, or fitting configured to connect to an air hose or tubing to receive compressed air, and an additional adapter, connector, or fitting configured to connect to another hose or tubing for liquid, such as water or a liquid cleaning solution. In other cases, the inlet 504 can include an opening for receiving concentric hoses or tubing for both air and liquid, or an adapter, connector, or fitting configured to receive the concentric hoses. The concentric hoses or tubing can include a hose or tubing for liquid inside of another hose or tubing for air, or vice versa.

The inlet 504 can be part of, or connected to, a structure 506 of the self-cleaning sensor apparatus 500 that has a hollow path for the compressed air (and, in some cases, liquid) inside of the structure 506 and/or the hose or tubing for carrying compressed air (and in some cases, the hose or tubing for carrying liquid). The compressed air received through the inlet 504 can travel through the hollow path of the structure 506 (and/or through a hose or tubing disposed at least partially inside of the hollow path of the structure 506) to a manifold 510 with nozzles 512 configured to output the compressed air. In cases where the inlet 504 is configured to receive both compressed air and liquid, the compressed air and the liquid received through the inlet 504 can travel through the hollow path of the structure 506 (and/or through respective hoses or tubes disposed at least partially inside of the hollow path of the structure 506) to the manifold 510 with the nozzles 512.

In some examples where the inlet 504 is configured to receive both compressed air and liquid, the structure 506 can include a hollow path for compressed air and another hollow path for liquid. The hollow path for compressed air and the hollow path for liquid can be separated from each other so as to separately carry the compressed air and the liquid and prevent the compressed air and liquid from mixing or coming in contact with each other.

In some cases where the nozzles 512 in the manifold 510 are configured to output both compressed air and liquid, some of the nozzles 512 can be configured to output compressed air and the other nozzles can be configured to output liquid. Thus, in such examples, each nozzle in the manifold 510 can be configured to output either liquid or compressed air. For example, one or more nozzles in the manifold 510 can output compressed air carried through one or more hollow paths in the structure 506 and manifold 510 and/or through one or more hoses or tubes for compressed air that are included within the one or more hollow paths. Similarly, one or more other nozzles in the manifold 510 can output liquid carried through one or more other hollow paths in the structure 506 and manifold 510 and/or through one or more other hoses or tubes for liquid that are included within the one or more hollow paths. In other cases, one or more of the nozzles 512 in the manifold 510 can be configured to output both liquid and compressed air.

The manifold 510 can be positioned relative to the cylindrical sensor 502 (e.g., relative to a lens and/or surface of the cylindrical sensor 502) without making direct contact with the cylindrical sensor 502. The nozzles 512 (e.g., an outlet of the nozzles 512) in the manifold 510 can face towards the cylindrical sensor 502 to ensure they output the compressed air (and, in some cases, liquid) towards the cylindrical sensor 502. In other words, the direction of the output (e.g., compressed air and, in some cases, liquid) from the nozzles 512 is towards the cylindrical sensor 502 (e.g., towards a lens and/or surface of the cylindrical sensor 502).

The manifold 510 can be positioned at a certain distance or phase angle from the cylindrical sensor 502. The distance or phase angle can vary in different implementations. In some examples, the distance between the manifold 510 (and thus the nozzles 512) and the cylindrical sensor 502 can be within a threshold to prevent the nozzles 512 from being positioned beyond a certain distance from the cylindrical sensor 502, in order to maximize the pressure, velocity, and/or force of (and/or applied by) the output (e.g., compressed air and, in some cases, liquid) from the nozzles 512 on the cylindrical sensor 502 (e.g., on a lens or surface of the cylindrical sensor 502. By reducing the distance between the manifold 510 (and thus the nozzles 512) and the cylindrical sensor 502 and thereby maximizing the pressure, force, and/or velocity of the air or liquid on the cylindrical sensor 502 by the output from the nozzles 512, the output from the nozzles 512 can better force any precipitation (e.g., droplets), dirt, debris, dust, and/or particles from the surface or lens of the cylindrical sensor 502, which can result in better cleaning performance.

In some cases, the distance between the cylindrical sensor 502 and the manifold 510 can be reduced as much as possible without causing the manifold 510 to come in contact with the cylindrical sensor 502, as such contact could potentially damage the cylindrical sensor 502. In other words, the distance of the manifold 510 from the cylindrical sensor 502 can be reduced as much as possible while maintaining the manifold 510 at a contactless position relative to the cylindrical sensor 502. In some cases, the manifold 510 can include one or more bearing surfaces 514 configured to make contact with the cylindrical sensor 502 and/or configured to absorb at least some of an impact between the manifold 510 and the cylindrical sensor 502 that may be caused by any movement of the manifold 510, any movement of the cylindrical sensor 502, and/or any external forces on the manifold 510 and/or the cylindrical sensor 502. In some cases, the manifold 510 can include a single bearing surface. In other cases, the manifold 510 can include multiple bearing surfaces. For example, the manifold 510 can include a bearing surface on a portion of the manifold 510 above the nozzles 512, and another bearing surface on a portion of the manifold 510 below the nozzles 512, such as a lowest portion of the manifold 510. In some examples, each of the one or more bearing surfaces 514 can include a slider or bumper.

The bearing surfaces 514 can include a material that is capable of minimizing friction and/or absorbing at least some of an impact between the manifold 510 and the cylindrical sensor 502. For example, the bearing surfaces 514 can be at least partially made of a material that is capable of absorbing an impact, such as rubber. By absorbing at least some of the impact between the manifold 510 and the cylindrical sensor 502, the one or more bearing surfaces 514 can prevent or reduce any damage to the cylindrical sensor 502 that can result from an impact between the manifold 510 and the cylindrical sensor 502. In some cases, the one or more bearing surfaces 514 can be sized/shaped to increase the surface area of any impact between the one or more bearing surfaces 514 and the cylindrical sensor 502 (e.g., relative to the surface area of such impact if the manifold 510 did not include the one or more bearing surfaces 514). By increasing the surface area of any impact between the manifold 510 and the cylindrical sensor 502, the one or more bearing surfaces 514 can reduce the pressure (e.g., force per unit of area) on the cylindrical sensor 502 caused by such an impact.

As previously explained, the relative distance and/or phase angle of the nozzles 512 and the cylindrical sensor 502 can affect the pressure and/or force of the output (e.g., compressed air and, in some cases, liquid) of the nozzles 512 on the cylindrical sensor 502. Similarly, the size or diameter of the output holes in the nozzles 512 used to emit the output from the nozzles 512 can also affect the pressure and/or force of the output on the cylindrical sensor 502. For example, the size or diameter of the output holes in the nozzles 512 can be reduced to create a choked flow that reduces the total flow rate but increases the flow velocity and pressure/force. Thus, in some cases, the size or diameter of the output holes in the nozzles 512 can be optimized to increase the pressure and/or force on the cylindrical sensor 502 of the output from the nozzles 512.

In some examples, the size or diameter of the output holes in the nozzles 512 can be determined based on a desired amount of pressure, force and/or velocity of the output on the (e.g., applied to) cylindrical sensor 502 and/or a desired amount of output from the nozzles 512. For example, larger sizes or diameters of the output holes in the nozzles 512 can result in higher amounts of air (and, in some cases, liquid) emitted by the nozzles 512, while smaller sizes or diameters of the holes in the nozzles 512 can result in more pressure, force, and/or velocity generated by the output emitted by the nozzles 512 on the cylindrical sensor 502. Thus, the output amount from the nozzles 512 and the amount of pressure and/or force of the output from the nozzles 512 can be taken into account when determining the size or diameter of the output holes on the nozzles 512.

In some cases, the air and/or fluid cleaning efficacy of the self-cleaning sensor apparatus 500 and the consumption of air and/or fluid by the self-cleaning sensor apparatus 500 can be optimized based on a number of parameters. Non-limiting examples of parameters that can be used to optimize the air and/or fluid cleaning efficacy of the self-cleaning sensor apparatus 500 and the consumption of air and/or fluid by the self-cleaning sensor apparatus 500 can include the air and/or fluid cleaning efficacy of the self-cleaning sensor apparatus 500 and the consumption of air and/or fluid by the self-cleaning sensor apparatus 500 can be optimized based on the diameter of the output holes in the nozzles 512; the distance from the output holes of the nozzles 512 to the target surface to be cleaned (e.g., an optical surface of the cylindrical sensor 502); an arrangement, spacing, an angle and/or area of coverage of the output holes in the nozzles 512, and/or a pointing direction and/or angle of the output holes in the nozzles 512; a number of output holes in the nozzles 512; an inlet pressure and flow; a pose of the nozzles 512 and/or the output holes in the nozzles 512 relative to the cylindrical sensor 502, which can optimize for aerodynamic flow and/or forces while the vehicle is moving; among others.

In some aspects, the nozzles 512 can be removed or replaced from the cylindrical sensor. For example, the nozzles 512 can be pressed or threaded into holes on the manifold 510 to secure the nozzles 512 in the manifold 510, and/or pulled or unthreaded from the holes on the manifold 510. Making the nozzles 512 removable/replaceable can reduce a cost of maintenance, as it allows for the nozzles 512 to be exchanged when clogged, damaged, and/or worn out without replacing the full manifold 510. The nozzles 512 can be configured with different diameters for different flow rates, different spray patterns, and/or different cleaning uses cases and/or preferences.

In some examples, the manifold 510 can be disposed at a downward angle relative to a top surface of the cylindrical sensor 502. In some cases, the manifold 510 can have a helical shape or a partly helical shape. The helical shape or partly helical shape can allow the output (e.g., compressed air and, in some cases, liquid) from the nozzles 512 to push any moisture and/or particles on the lens or surface of the cylindrical sensor 502 in a downward direction aligned with gravity (e.g., relative to a vertical axis of the cylindrical sensor 502) and thus away from the sensing elements (e.g., transmitters, receivers) of the cylindrical sensor 502. By pushing any moisture and/or particles on the lens or surface of the cylindrical sensor 502 in the downward direction (and thus away from the sensing elements), the output from the nozzles 512 can prevent obstructions/occlusions in the field-of-view (FOV) of the cylindrical sensor 502. In some cases, the air output by the nozzles 512 can create a blade of air to clean the cylindrical sensor 502 and/or remove moisture/droplets, as further explained herein.

In some cases, the manifold 510 and/or the nozzles 512 can be disposed at an upward angle relative to a bottom surface of the cylindrical sensor 502. For example, the nozzles 512 can point in an upward direction (or partially upward direction) relative to a position of the nozzles 512, and can be configured to output air and/or fluid in the upward direction (or partially upward direction) and towards the lens or surface of the cylindrical sensor 502. In cases where the cylindrical sensor 502 is bottom mounted on a vehicle, aerodynamic forces can push any fluid droplets (e.g., including any droplets from fluid sprayed by the nozzles 512) and/or any particles on the cylindrical sensor 502 upward and away from the cylindrical sensor 502.

In some examples, outputs (e.g., air and, in some cases, liquid) from the nozzles 512 can be triggered at periodic intervals. For example, a controller device (not shown) can trigger compressed air to be provided to the inlet 504 and output through one or more of the nozzles 512 at periodic intervals. In some cases, the controller device can also trigger liquid to be provided to the inlet 504 and output through one or more of the nozzles 512 at periodic intervals (e.g., before or after an output of air by one or more of the nozzles 512).

In other examples, outputs (e.g., air and, in some cases, liquid) from the nozzles 512 can be triggered based on a determination that the cylindrical sensor 502 needs to be cleaned. For example, a controller device (not shown) can trigger outputs (e.g., air and, in some cases, liquid) from the nozzles 512 based on a detection of moisture, dirt, dust, debris, and/or other particles on the cylindrical sensor 502. In some cases, the controller device can detect moisture, dirt, dust, debris, and/or other particles on the cylindrical sensor 502 based on the data collected by the cylindrical sensor 502. For example, the controller device can implement a computer vision algorithm to detect any obstructions/occlusions reflected in the data collected by the cylindrical sensor 502, and determine that the obstructions/occlusions are caused by moisture, dirt, dust, debris, and/or other particles on the lens or surface of the cylindrical sensor 502. As another example, the controller device can implement a machine learning model, such as a neural network, to detect any obstructions/occlusions reflected in the data collected by the cylindrical sensor 502, and determine that the obstructions/occlusions are caused by moisture, dirt, dust, debris, and/or other particles on the lens or surface of the cylindrical sensor 502.

As another example, the controller device can implement a computer vision algorithm and/or machine learning neural network to determine one or more characteristics of signals sent and/or received by the cylindrical sensor 502 (and/or one or more characteristics of sensor data collected by the cylindrical sensor 502) and, based on the one or more characteristics of the signals sent and/or received (and/or the one or more characteristics of the sensor data), determine that the lens or surface of the cylindrical sensor 502 has moisture, dirt, dust, debris, and/or other particles and needs to be cleaned.

As yet another example, the controller device can implement an algorithm to monitor any backscatter from the data collected by the cylindrical sensor 502. When the controller device detects backscatter, it can determine that the cylindrical sensor 502 needs to be cleaned and trigger a cleaning of the cylindrical sensor 502 as further described herein. For example, if there is dirt, dust, debris, moisture, and/or other particles on a lens or surface of the cylindrical sensor 502, the dirt, dust, debris, moisture, and/or other particles can cause crosstalk between adjacent channels of the sensing elements of the cylindrical sensor 502. The controller device can detect such crosstalk from the data collected by the cylindrical sensor 502, and trigger a cleaning of the cylindrical sensor 502.

In other cases, the controller device can detect moisture, dirt, dust, debris, and/or other particles on the cylindrical sensor 502 based on data from one or more other sensors. For example, a rain sensor can be implemented to detect any moisture on the lens or surface of the cylindrical sensor 502. The controller device can use the data from the rain sensor to determine whether there is any moisture in the lens or surface of the cylindrical sensor 502. In other examples, the controller device can detect moisture, dirt, dust, debris, and/or other particles on the cylindrical sensor 502 based on data from one or more image sensors. For example, the one or more image sensors can capture images (e.g., still images or video frames) depicting the lens or surface of the cylindrical sensor 502. The controller device can implement a computer vision algorithm to analyze the images from the one or more sensors and detect any moisture, dirt, dust, debris, and/or other particles on the cylindrical sensor 502.

The number of nozzles implemented by the manifold 510 can vary based on one or more factors. For example, the number of nozzles on the manifold 510 can depend on whether to include nozzles for compressed air as well as liquid. To illustrate, when the self-cleaning sensor apparatus 500 uses the nozzles 512 on the manifold 510 to emit both air and liquid, the number of nozzles on the manifold 510 can be increased to include one or more nozzles for air and one or more additional nozzles for liquid. As another example, in some cases, the number of nozzles on the manifold 510 can depend on the space available on the manifold 510 for implementing nozzles (e.g., more nozzles can be included when the manifold 510 has more space for nozzles) and/or the spray angles of the nozzles (e.g., less nozzles may be implemented in cases where the spray angles of the nozzles correspond to a larger angle of coverage). In some cases, the number of nozzles implemented by the manifold 510 can at least partially depend on the total flow rate of the air or liquid utilized, the rotational rate of the manifold 510, and/or the number of rotations of the manifold 510 used for cleaning the cylindrical sensor 502.

To increase the cleaning area of the nozzles 512, the self-cleaning sensor apparatus 500 can be configured to rotate the manifold 510 with the nozzles 512 around the cylindrical sensor 502 (e.g., around the entire circumference of the cylindrical sensor 502 or a portion of the circumference of the cylindrical sensor 502). In some examples, the self-cleaning sensor apparatus 500 can include gears 516 and 518 configured to rotate the manifold 510. The gears 516 and 518 can be rotated by a motor 520, such as a brushed DC motor or any other motor. Rotation of the gear 516 can cause the gear 518 and a rotary joint 522 to rotate. The rotary joint 522 can be directly or indirectly coupled to the manifold 510. For example, in some cases, the rotary joint 522 can be connected to an attachment structure 528 that connects to the manifold 510. The attachment structure 528 can attach the manifold 510 to the rest of the self-cleaning sensor apparatus 500 and can rotate with the gear 518 and the rotary joint 522.

Thus, the rotation of the gear 518 and the rotary joint 522 can cause the manifold 510 to also rotate. In some cases, the self-cleaning sensor apparatus 500 can include one of more bearings 526 around the rotary joint 522 to enable free rotation of the rotary joint 522 around a fixed axis. In the illustrative example shown in FIG. 5, the self-cleaning sensor apparatus 500 includes two bearings (e.g., bearings 526) around the rotary joint 522.

As previously explained, in some cases, the cylindrical sensor 502 and/or the sensing elements of the cylindrical sensor 502 can be configured to rotate to increase the FOV and/or coverage of the cylindrical sensor 502. In some examples, to prevent the manifold 510 from blocking a FOV of the cylindrical sensor 502 when the cylindrical sensor 502 and/or the sensing elements of the cylindrical sensor 502 are rotated, the rotation of the manifold 510 can synchronized with the rotation of the cylindrical sensor 502 and/or the sensing elements of the cylindrical sensor 502 so the manifold 510 remains within a leading angle or phase or a lagging angle or phase from the sensing elements of the cylindrical sensor. For example, in some cases, the manifold 510 can be configured to rotate at a same frequency/speed as the cylindrical sensor 502 and/or the sensing elements of the cylindrical sensor 502. The manifold 510 can be configured to lag or lead the cylindrical sensor 502 and/or the sensing elements of the cylindrical sensor 502 as the manifold 510 rotates at the same frequency/speed as the cylindrical sensor 502 and/or the sensing elements of the cylindrical sensor 502.

To illustrate, as the manifold 510 and the sensing elements of the cylindrical sensor 502 are rotated, the manifold 510 can maintain a phase angle behind or ahead of the sensing elements of the cylindrical sensor 502 along an axis of rotation associated with the manifold 510 and the sensing elements of the cylindrical sensor 502. In some cases, the rotation of the manifold 510 and the cylindrical sensor 502 (and/or the sensing elements of the cylindrical sensor 502) can be synchronized by a controller device (not shown). In some examples, the rotation of the manifold 510 and the cylindrical sensor 502 can be controlled/synchronized by a controller device and a rotary encoder 542. The rotary encoder 542 can be directly or indirectly coupled to the motor 520, the gear 516, the gear 518, an actuator system of the cylindrical sensor 502, and/or placed at another location. For example, the rotary encoder 542 can be directly or indirectly coupled to a back shaft of the motor 520, the gear 516, or the gear 518. In other cases, the rotary joint 522 can be directly or indirectly coupled to the manifold 510 and the cylindrical sensor 502. Thus, the rotational force imparted by the rotary joint 522 can cause the manifold 510 and the cylindrical sensor 502 (and/or sensing elements of the cylindrical sensor 502) to rotate at a same speed/frequency, with the manifold 510 positioned out-of-phase (e.g., positioned to lag or lead) relative to the cylindrical sensor 502 (and/or the sensing elements of the cylindrical sensor 502) to prevent obstructing a FOV of the cylindrical sensor 502.

In some examples, the rotary joint 522 can be directly or indirectly coupled to the manifold 510 and a spindle of the cylindrical sensor 502. Thus, the rotational force imparted on the spindle by the rotary joint 522 can cause the cylindrical sensor 502 (and/or sensing elements of the cylindrical sensor 502) to rotate at a same speed/frequency as the manifold 510 (which is rotated by the rotary joint 522), with the manifold 510 positioned out-of-phase relative to the cylindrical sensor 502 (and/or the sensing elements of the cylindrical sensor 502) to prevent obstructing a FOV of the cylindrical sensor 502.

In some cases, instead of rotating the manifold 510 around the full circumference of the cylindrical sensor 502, the manifold 510 can be rotated around less than the full circumference of the cylindrical sensor 502 and parked at a home position when the manifold 510 is not rotated. For example, the self-cleaning sensor apparatus 500 can include a parking brake 540 that stops a rotation of the manifold 510 and positions the manifold 510 at a parked location. In some examples, the parking brake 540 can include an electrically-actuated solenoid. To stop the manifold 510 from rotating, the solenoid can engage a hole in the gear 518 to stop rotation of the manifold 510. For example, the solenoid can release a plunger or pin into the hole in the gear 518 to stop rotation of the manifold 510 by stopping rotation of the gear 518.

In some implementation, the self-cleaning sensor apparatus 500 may not include the parking brake 540. In other implementations where the self-cleaning sensor apparatus 500 includes the parking brake 540, the manifold 510 may rotate less than a full rotation around the cylindrical sensor 502 and park at a home position as described herein. In yet other implementations where the self-cleaning sensor apparatus 500 includes the parking brake 540, the manifold 510 may oscillate and/or may free spin one or more rotations around the cylindrical sensor 502 before being parked at the home location by the parking brake 540.

In some cases, the parking brake 540 can park the manifold 510 within a portion of the FOV of the cylindrical sensor 502 that is already blocked or obstructed by the motor 520. For example, the parking brake 540 can park the manifold 510 between the motor 520 and the lens or surface of the cylindrical sensor 502.

To minimize the loss of FOV of the cylindrical sensor 502 from a FOV obstruction by the motor 520, in some cases, the motor 520 can be positioned above the cylindrical sensor 502 (e.g., by rotating the motor 520 180 degrees relative to the position of the motor 520 shown in FIG. 5). In other cases, the motor 520 can be rotated 90 degrees relative to the position of the motor 520 shown in FIG. 5 to provide a 90 degree transfer without (or while limiting) an obstruction by the motor 520 of the FOV of the cylindrical sensor 502. For example, the motor 520 can be positioned outside of the FOV of the cylindrical sensor 502 and coupled to a 90 degree bevel gear mesh configured to rotate the manifold 510.

In some cases, the self-cleaning sensor apparatus 500 can include a counterweight 530 on an opposite side of the manifold 510. The counterweight 530 can be directly or indirectly coupled to the attachment structure 528. The counterweight 530 can counter a weight and/or force of the attachment structure 528 and the manifold 510. In some examples, the counterweight 530 can help maintain the self-cleaning sensor apparatus 500 and/or the manifold 510 balanced, can reduce or limit the centripetal force on the side of the self-cleaning sensor apparatus 500 where the manifold 510 is positioned at any one time, keep the self-cleaning sensor apparatus 500 and/or the manifold 510 centered, and prevent or reduce any wobbling of the self-cleaning sensor apparatus 500 and/or the manifold 510 when the manifold 510 is rotated.

In some aspects, the self-cleaning sensor apparatus 500 can include a ring 532 with nozzles 534 configured to spray a cleaning liquid, such as water or any other liquid or cleaning solution. In some aspects, the ring 532 can be disposed at a certain distance below the manifold 510. In some cases, the ring 532 can be disposed below the manifold 510 and one or more sensing elements of the cylindrical sensor 502. In some cases, the ring 532 can be disposed so as to surround an exterior surface of the cylindrical sensor 502. The exterior surface can be, for example, a surface of a lens of the cylindrical sensor 502 and/or a surface configured to send and receive optical signals associated with the cylindrical sensor 502. In some examples, the ring 532 can be disposed around an exterior surface of the cylindrical sensor 502 and either below a bottom surface of the cylindrical sensor 502, at the bottom surface of the cylindrical sensor 502, or a threshold distance above the bottom surface of the cylindrical sensor 502. In some cases, the ring 532 can be disposed about the cylindrical sensor 502 with or without making contact the cylindrical sensor 502.

The nozzles 534 can be located around the ring 532. In some examples, the nozzles 534 can be located around the ring 532 and outside of a circumference of the cylindrical sensor 502 so as to allow the nozzles 534 to spray liquid on an exterior surface of the cylindrical sensor 502. In some examples, the nozzles 534 can be spaced apart around the ring 532 at one or more distances from each other. The number of nozzles 534 in the ring 532 and the spacing between the nozzles 534 around the ring 532 can vary or can be based on one or more factors such as, for example and without limitation, a size of the ring 532, a size of the cylindrical sensor 502, an intended use case or application of the self-cleaning sensor apparatus 500 (e.g., implementation on an AV, implementation on an aerial vehicle, implementation on a particular environment (e.g., a dry or desert environment, a wet or tropical environment, a cold or artic environment), implementation on an autonomous robotic device, etc.), a configuration of the nozzles 534 (e.g., a size or diameter of the nozzles 534, a shape of the nozzles 534, a spraying angle of the nozzles 534, a spraying coverage of each nozzle, a desired flow rate of the liquid to be sprayed by the nozzles 534, and/or any other factor.

Moreover, the nozzles 534 can include or can be connected to hoses 536 that can provide liquid to the nozzles 534, which the nozzles 534 can use to spray a lens or surface of the cylindrical sensor 502 during a cleaning event. In some examples, each of the nozzles 534 includes or is connected to a respective hose or tube. The nozzles 534 can spray liquid (e.g., water or any other liquid or cleaning solution) on the lens or surface of the cylindrical sensor 502 to help clean the lens or surface of the cylindrical sensor 502. In some examples, the nozzles 534 can be configured to spray liquid on the lens or surface of the cylindrical sensor 502, and the nozzles 512 on the manifold 510 can be configured to subsequently spray air on the lens or surface of the cylindrical sensor 502 to remove the liquid and any droplets from the lens or surface of the cylindrical sensor 502. The manifold 510 can sit above the ring 532 and nozzles 534 to push (e.g., via the air sprayed by the nozzles 512 of the manifold 510) the liquid from the nozzles 534 down and off the lens or surface of the cylindrical sensor 502. As previously explained, the manifold 510 can have a helical shape, which can help the nozzles 512 of the manifold 510 push moisture on the lens or surface of the cylindrical sensor 502 down (e.g., relative to a vertical axis of the cylindrical sensor 502) and away from the lens or surface of the cylindrical sensor 502.

When in use, the self-cleaning sensor apparatus 500 can be mounted on the AV 102. The self-cleaning sensor apparatus 500 can be mounted on the AV 102 using a sensor mount (not shown). In some cases, the self-cleaning sensor apparatus 500 can be mounted on a testing bracket to conduct tests before the self-cleaning sensor apparatus 500 is mounted on the AV 102 for use by the AV 102. FIG. 5 shows the self-cleaning sensor apparatus 500 mounted on an example testing bracket 538.

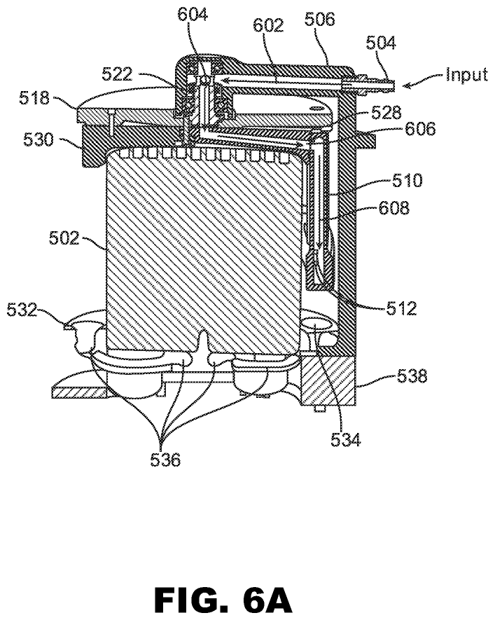

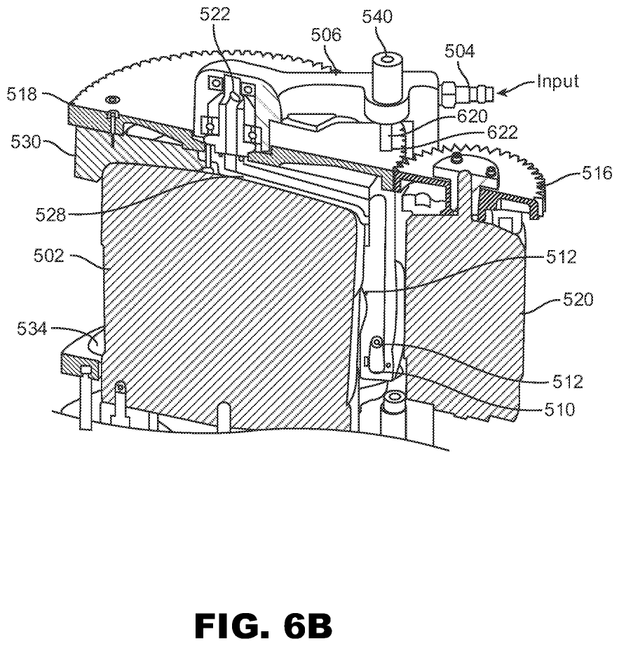

FIG. 6A is a diagram illustrating an example path of air emitted by the nozzles 512 of the manifold 510. As shown in the example, the air can first be provided through the inlet 504. The air can then flow through a path 602 inside of the structure 506 to a path 604 inside of the rotary joint 522. The air then continues through a path 606 inside of the attachment structure 528 that connects to the manifold 510.

From the path 606 in the attachment structure 528, the air can flow through a path 608 inside of the manifold 510. From the path 608 inside the manifold 510, the air can reach the nozzles 512 of the manifold 510, which can spray the air toward the cylindrical sensor 502.

In other examples, the paths 602-608 can house one or more hoses or tubes to carry the air and/or liquid for cleaning the cylindrical sensor 502. In such examples, the one or more hoses or tubes can carry the air and/or liquid from the inlet 504 to the nozzles 512 of the manifold 510. The nozzles 512 of the manifold 510 can then output the air and/or liquid toward the cylindrical sensor 502 as part of a cleaning event.

FIG. 6B is a diagram illustrating an example view of the drive system and parking brake of the self-cleaning sensor apparatus. As shown, the gear 518 is coupled to the attachment structure 528 and the counterweight 530. The attachment structure 528 is coupled to the manifold 510 and can hold and/or secure the manifold 510.

To stop rotation of the manifold 510, the parking brake 540 can release a pin 620 or plunger into a hole 622 in the gear 518. When the pin 620 is released into the hole 622 in the gear 518, the pin 620 can prevent the gear 518 from rotating. Since the gear 518 is indirectly coupled to the manifold 510 and drives the rotation of the manifold 510, by stopping rotation of the gear 518, the parking brake 540 can stop rotation of the manifold 510.

In some cases, rotation of the manifold 510 and/or the cylindrical sensor 502 can be aided or generated by one or more components in addition to or in lieu of the motor 520. For example, the nozzles 512 of the manifold 510 can be angled to provide or aid in a propulsion of the manifold 510 similar to a propulsion of a rocket. In this way, the nozzles 512 can rotate or help rotate the manifold 510. In some cases, this can eliminate the need for a motor to rotate the manifold 510, which can provide numerous advantages such as, for example, space savings, cost savings, energy savings, etc. In other examples, the manifold 510 and/or the cylindrical sensor can be rotated by an alternative spinning drive.

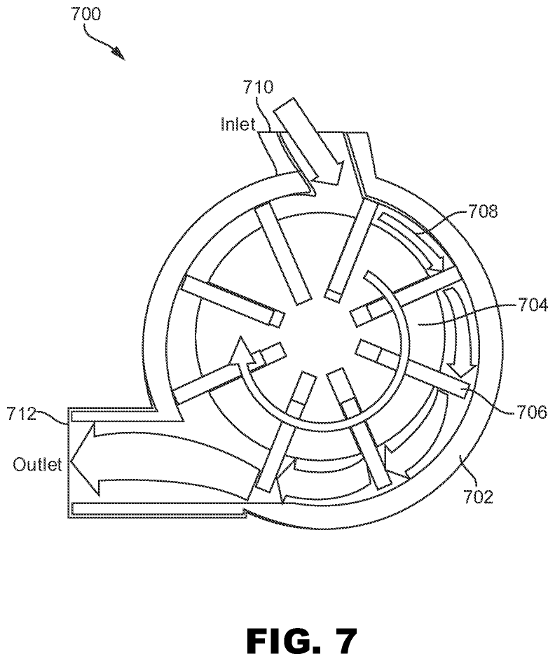

FIG. 7 is a diagram illustrating an example pneumatic motor 700 that can provide an alternative spinning drive for the self-cleaning sensor apparatus 500, according to some examples of the present disclosure. The pneumatic motor 700 can be used to rotate the manifold 510, and can be implemented as an alternative to the actuation system with the motor 520 and the gears 516 and 518 shown in FIG. 5. In some examples, the pneumatic motor 700 can reduce the battery load otherwise needed to power the motor 520 shown in FIG. 5, as it instead relies on air to produce the rotational motion. In some cases, the pneumatic motor 700 can also conserve space relative to the actuation system described in FIG. 5.

In FIG. 7, the pneumatic motor 700 includes a stator 702, a rotor 704, and vanes 706 used to create rotational motion used to rotate the manifold 510. The pneumatic motor 700 can include a chamber 708 for air pumped through the inlet 710 of the pneumatic motor 700. When the air is pumped through the inlet 710, the air can push the vanes 706 as it flows through the chamber 708 to the outlet 712. By pushing the vanes 706, the air can cause the vanes 706 to rotate and thereby create the rotational motion.

In some examples, the air pumped through the inlet 710 can include different compressed air than the compressed air used to clean the cylindrical sensor 502, as previously explained. In other examples, the air pumped through the inlet 710 can include the same compressed air used to clean the cylindrical sensor 502. Such reuse of the compressed air can reduce costs, space, and/or complexity.

The rotational motion created by the pneumatic motor 700 from the air pumped into the pneumatic motor 700 can be used to rotate the manifold 510, the cylindrical sensor 502, and/or a spindle of the cylindrical sensor 502. For example, in some cases, the rotational motion created by the pneumatic motor 700 can be used to rotate a spindle of the cylindrical sensor 502 to thereby rotate the cylindrical sensor 502. In other examples, the rotational motion created by the pneumatic motor 700 can be used to rotate the manifold 510 or both the manifold 510 and the cylindrical sensor 502.

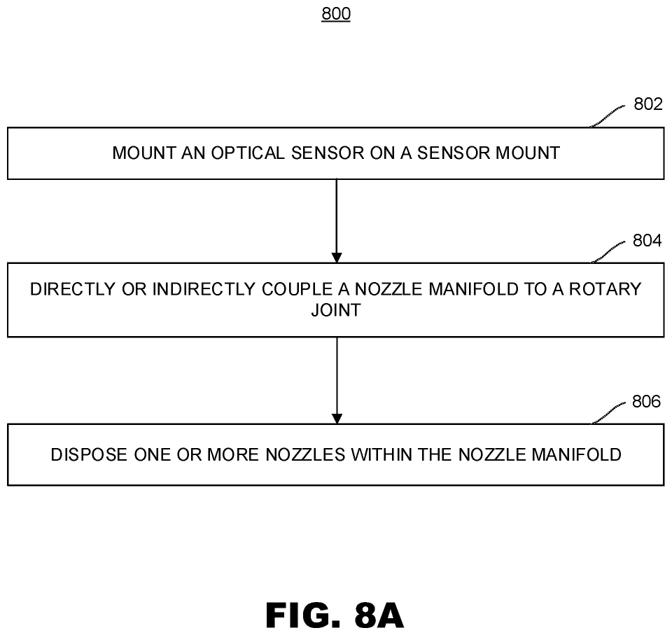

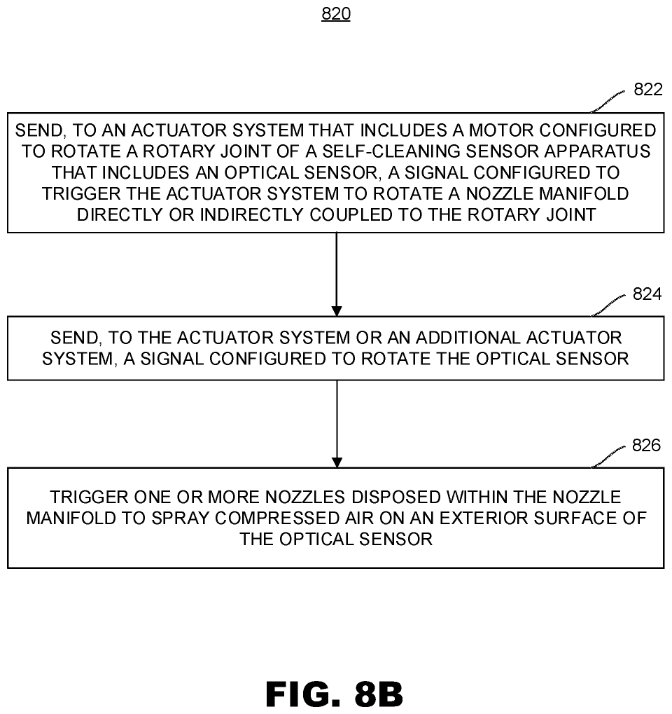

FIG. 8A is a flowchart illustrating an example process 800 for constructing a self-cleaning apparatus, according to some examples of the present disclosure. At block 802, the process 800 can include mounting an optical sensor (e.g., cylindrical sensor 502) on a sensor mount. The optical sensor can be part of a self-cleaning apparatus (e.g., self-cleaning sensor apparatus 500), as further described herein. Moreover, the optical sensor can include, for example and without limitation, a LIDAR, an image sensor, etc. The sensor mount can include, for example, a bracket, platform, attachment mechanism, and/or any mount configured to secure all of the components of the self-cleaning apparatus including the optical sensor. In some examples, the sensor mount can be configured to secure all of the components of the self-cleaning apparatus and attach/secure the self-cleaning apparatus to an AV (e.g., AV 102).

At block 804, the process 800 can include directly or indirectly coupling a nozzle manifold (e.g., manifold 510) to a rotary joint. In some examples, the nozzle manifold can be configured to rotate in response to a rotation of the rotary joint (e.g., rotary joint 522). In some examples, the nozzle manifold can be disposed at a downward angle relative to a surface of the optical sensor. In some cases, the surface can be a top surface of the optical sensor.

At block 806, the process 800 can include disposing one or more nozzles (e.g., nozzles 512) within the nozzle manifold. In some examples, the one or more nozzles can be configured to spray compressed air on an exterior surface of the optical sensor. The exterior surface can include an optical surface configured to send and receive optical signals associated with the optical sensor. In some examples, the exterior surface can include a surface of a lens of the optical sensor.

In some examples, the nozzle manifold can have a helical shape or a partly helical shape. As previously explained, the helical shape or partly helical shape can help the one or more nozzles of the nozzle manifold push moisture on the exterior surface of the optical sensor down (e.g., relative to a vertical axis of the optical sensor) and away from the exterior surface of the optical sensor.

In some aspects, the process 800 can include disposing a ring device (e.g., ring 532) at a distance below the nozzle manifold and one or more sensing elements of the optical sensor. In some examples, the ring device can be disposed so as to surround the exterior surface of the optical sensor. In some cases, the ring device can be disposed around the exterior surface of the optical sensor and either below a bottom surface of the optical sensor, at the bottom surface of the optical sensor, or a threshold distance above the bottom surface of the optical sensor. Moreover, the ring device can be disposed so as to surround the exterior surface of the optical sensor with or without making contact with the optical sensor.

In some examples, the ring device can include one or more additional nozzles (e.g., nozzles 534) associated with one or more hoses (e.g., hoses 536) configured to provide a cleaning liquid (e.g., water, a cleaning fluid, or any other fluid) to the one or more additional nozzles. In some examples, the one or more additional nozzles can be configured to spray the exterior surface of the optical sensor with the one or more cleaning liquids from the one or more hoses.

In some aspects, the process 800 can further include coupling a spindle or actuator system to the optical sensor, and coupling a same or different actuator system to the rotary joint. The spindle or actuator system can be configured to rotate the optical sensor. Moreover, the same or different actuator system can be configured to rotate the nozzle manifold via the rotary joint at a same or substantially similar rotational speed as the optical sensor.

In some examples, the nozzle manifold can be configured to rotate about the exterior surface of the optical sensor without contacting the exterior surface of the optical sensor.

In some examples, the actuator system configured to rotate the rotary joint and the nozzle manifold can include a first gear rotatably coupled to a motor and a second gear in contact with the first gear. In some cases, the second gear is configured to rotate in response to rotation of the first gear, and the rotary joint can be coupled (directly or indirectly) to the second gear and configured to rotate with the second gear. In some implementations, the actuator system can be a belt-driven reduction or can have multiple stages of various gear reductions as needed to vary the motor size, torque, and/or speed. In some aspects, the self-cleaning sensor apparatus can include a counterweight directly or indirectly coupled to the nozzle manifold. The counterweight can provide a weight to counter the weight of the nozzle manifold.

FIG. 8B is a flowchart illustrating an example process 820 for using a self-cleaning apparatus, according to some examples of the present disclosure. At block 822, the process 820 can include sending, to an actuator system that includes a motor (e.g., motor 520) configured to rotate a rotary joint (e.g., rotary joint 522) of a self-cleaning sensor apparatus (e.g., self-cleaning sensor apparatus 500) that includes an optical sensor (e.g., cylindrical sensor 502), a signal configured to trigger the actuator system to rotate a nozzle manifold (e.g., manifold 510) directly or indirectly coupled to the rotary joint. In some examples, the signal can be configured to rotate the rotary joint, and the rotation of the rotary joint can cause the nozzle manifold to rotate. In some examples, the nozzle manifold can be disposed at a downward angle relative to a surface of the optical sensor located at a top portion of the optical sensor.

At block 824, the process 820 can include sending, to the actuator system or an additional actuator system, a signal configured to rotate the optical sensor. In some examples, the optical sensor can be rotated by the same actuator system as the rotary joint, and the signal to trigger the actuator system to rotate the optical sensor can be the same signal or a different signal as the signal to trigger the actuator system to rotate the rotary joint. In other examples, the optical sensor can be rotated by a different actuator system (e.g., the additional actuator system) than the rotary joint, and the signal to trigger the different actuator system to rotate the optical sensor can be a different signal as the signal to trigger the actuator system to rotate the rotary joint. In some examples, the signal(s) can be configured to rotate the rotary joint and the optical sensor at a same speed/frequency or substantially the same speed/frequency. In some cases, rotating the rotary joint can cause the nozzle manifold to rotate, and the nozzle manifold can rotate out-of-phase (e.g., leading or lagging) relative to the rotation of the optical sensor.

At block 826, the process 820 can include triggering (e.g., via a signal) one or more nozzles (e.g., nozzles 512) disposed within the nozzle manifold to spray compressed air on an exterior surface of the optical sensor. In some examples, the exterior surface can include an optical surface configured to send and receive optical signals associated with the optical sensor. For example, the exterior surface can include a surface of a lens of the optical sensor. In some cases, the one or more nozzles can be triggered by a controller device, such as a processor, a driver system, a controller, a circuit, and/or any other component.

In some aspects, the process 820 can include triggering one or more additional nozzles (e.g., nozzles 534) on a ring device (e.g., ring 532) to spray the exterior surface of the optical sensor with a cleaning liquid from one or more hoses (e.g., hoses 536) associated with the one or more additional nozzles. The one or more hoses can be part of or connected to the one or more additional nozzles. In some cases, the one or more additional nozzles can be triggered by the controller device. In some examples, the one or more additional nozzles can be triggered to spray the cleaning liquid before the one or more nozzles on the nozzle manifold are triggered to spray the compressed air.

In some aspects, the process 820 can include determining, based on data from the optical sensor, that at least a portion of a field-of-view (FOV) or visibility of the optical sensor is at least partly obstructed or impaired by moisture and/or a plurality of particles and, in response to determining that at least the portion of the FOV or visibility of the optical sensor is at least partly obstructed or impaired by moisture and/or the plurality of particles, triggering the one or more additional nozzles to spray the cleaning liquid on the exterior surface of the optical sensor.

In some aspects, the process 820 can include in response to determining that at least a portion of the FOV or visibility of the optical sensor is at least partly obstructed or impaired by moisture and/or the plurality of particles, triggering the one or more nozzles to spray the compressed air on the exterior surface of the optical sensor.

In some examples, the nozzle manifold can be configured to rotate about the exterior surface of the optical sensor without contacting the exterior surface of the optical sensor.

In some examples, the actuator system can include a first gear rotatably coupled to the motor and a second gear in contact with the first gear. In some cases, the second gear is configured to rotate in response to rotation of the first gear, and the rotary joint can be coupled (directly or indirectly) to the second gear and configured to rotate with the second gear. In some aspects, the self-cleaning sensor apparatus can include a counterweight directly or indirectly coupled to the nozzle manifold. The counterweight can provide a weight to counter the weight of the nozzle manifold.

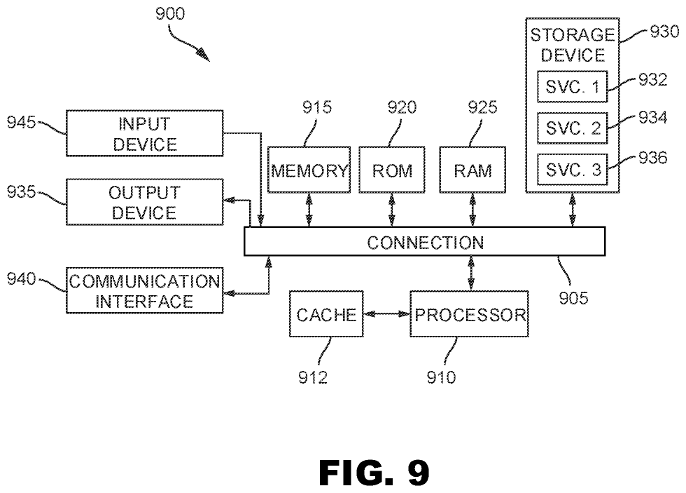

FIG. 9 illustrates an example processor-based system with which some aspects of the subject technology can be implemented. For example, processor-based system 900 can be any computing device making up internal computing system 110, remote computing system 190, a passenger device executing the ridesharing application 170, or any component thereof in which the components of the system are in communication with each other using connection 905. Connection 905 can be a physical connection via a bus, or a direct connection into processor 910, such as in a chipset architecture. Connection 905 can also be a virtual connection, networked connection, or logical connection.

In some embodiments, computing system 900 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 900 includes at least one processing unit (CPU or processor) 910 and connection 905 that couples various system components including system memory 915, such as read-only memory (ROM) 920 and random-access memory (RAM) 925 to processor 910. Computing system 900 can include a cache of high-speed memory 912 connected directly with, in close proximity to, and/or integrated as part of processor 910.

Processor 910 can include any general-purpose processor and a hardware service or software service, such as services 932, 934, and 936 stored in storage device 930, configured to control processor 910 as well as a special-purpose processor where software instructions are incorporated into the actual processor design. Processor 910 may essentially be a completely self-contained computing system, containing multiple cores or processors, a bus, memory controller, cache, etc. A multi-core processor may be symmetric or asymmetric.

To enable user interaction, computing system 900 includes an input device 945, which can represent any number of input mechanisms, such as a microphone for speech, a touch-sensitive screen for gesture or graphical input, keyboard, mouse, motion input, speech, etc. Computing system 900 can also include output device 935, which can be one or more of a number of output mechanisms known to those of skill in the art. In some instances, multimodal systems can enable a user to provide multiple types of input/output to communicate with computing system 900. Computing system 900 can include communications interface 940, which can generally govern and manage the user input and system output. The communication interface may perform or facilitate receipt and/or transmission wired or wireless communications via wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/9G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

Communications interface 940 may also include one or more Global Navigation Satellite System (GNSS) receivers or transceivers that are used to determine a location of the computing system 900 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 930 can be a non-volatile and/or non-transitory computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L9/L#), resistive random-access memory (RRAM/ReRAM), phase change memory (PCM), spin transfer torque RAM (STT-RAM), another memory chip or cartridge, and/or a combination thereof.

Storage device 930 can include software services, servers, services, etc., that when the code that defines such software is executed by the processor 910, it causes the system to perform a function. In some embodiments, a hardware service that performs a particular function can include the software component stored in a computer-readable medium in connection with the necessary hardware components, such as processor 910, connection 905, output device 935, etc., to carry out the function.

As understood by those of skill in the art, machine-learning based classification techniques can vary depending on the desired implementation. For example, machine-learning classification schemes can utilize one or more of the following, alone or in combination: hidden Markov models; recurrent neural networks; convolutional neural networks (CNNs); deep learning; Bayesian symbolic methods; general adversarial networks (GANs); support vector machines; image registration methods; applicable rule-based system. Where regression algorithms are used, they may include including but are not limited to: a Stochastic Gradient Descent Regressor, and/or a Passive Aggressive Regressor, etc.

Machine learning classification models can also be based on clustering algorithms (e.g., a Mini-batch K-means clustering algorithm), a recommendation algorithm (e.g., a Miniwise Hashing algorithm, or Euclidean Locality-Sensitive Hashing (LSH) algorithm), and/or an anomaly detection algorithm, such as a Local outlier factor. Additionally, machine-learning models can employ a dimensionality reduction approach, such as, one or more of: a Mini-batch Dictionary Learning algorithm, an Incremental Principal Component Analysis (PCA) algorithm, a Latent Dirichlet Allocation algorithm, and/or a Mini-batch K-means algorithm, etc.

Aspects within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general purpose computer, special purpose computer, or special purpose processing device to perform a certain function or group of functions. By way of example computer-executable instructions can be used to implement perception system functionality for determining when sensor cleaning operations are needed or should begin. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules can be located in both local and remote memory storage devices.

The various embodiments described above are provided by way of illustration only and should not be construed to limit the scope of the disclosure. For example, the principles herein apply equally to optimization as well as general improvements. Various modifications and changes may be made to the principles described herein without following the example aspects and applications illustrated and described herein, and without departing from the spirit and scope of the disclosure.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

What is claimed is:

1. A self-cleaning sensor apparatus, comprising:
an optical sensor;
an actuator system comprising a motor configured to rotate a rotary joint of the self-cleaning sensor apparatus;
a nozzle manifold directly or indirectly coupled to the rotary joint, wherein the nozzle manifold is configured to rotate in response to a rotation of the rotary joint, and wherein the nozzle manifold is disposed at an angle relative to a top or bottom surface of the optical sensor; and
one or more nozzles disposed within the nozzle manifold, the one or more nozzles being configured to spray compressed air on an exterior surface of the optical sensor, the exterior surface comprising at least one of a surface of a lens associated with the optical sensor and a surface configured to send and receive optical signals associated with the optical sensor.

2. The self-cleaning sensor apparatus of claim 1, further comprising a spindle configured to rotate the optical sensor, wherein the actuator system is configured to rotate the nozzle manifold via the rotary joint at a same or substantially similar rotational speed as the optical sensor.

3. The self-cleaning sensor apparatus of claim 1, further comprising a ring device comprising one or more additional nozzles associated with one or more hoses configured to provide a cleaning liquid to the one or more additional nozzles, and wherein the one or more additional nozzles are configured to spray the optical sensor with the cleaning liquid from the one or more hoses.

4. The self-cleaning sensor apparatus of claim 3, further comprising a controller device configured to:
trigger the one or more additional nozzles to spray the cleaning liquid on the exterior surface of the optical sensor; and
after triggering the one or more additional nozzles to spray the cleaning liquid on the exterior surface of the optical sensor, trigger the one or more nozzles disposed within the nozzle manifold to spray the compressed air on the exterior surface of the optical sensor.

5. The self-cleaning sensor apparatus of claim 4, further comprising a controller device configured to:
determine, based on data from the optical sensor, that at least a portion of a field-of-view (FOV) or visibility of the optical sensor is at least partly obstructed or impaired by at least one of moisture and a plurality of particles; and
in response to determining that at least the portion of the FOV or visibility of the optical sensor is at least partly obstructed or impaired by at least one of moisture and the plurality of particles, trigger the one or more additional nozzles to spray the cleaning liquid on the exterior surface of the optical sensor.

6. The self-cleaning sensor apparatus of claim 1, further comprising a controller device configured to:
determine, based on data from the optical sensor, that at least a portion of a field-of-view (FOV) or visibility of the optical sensor is at least partly obstructed or impaired by at least one of moisture and a plurality of particles; and
in response to determining that at least the portion of the FOV or visibility of the optical sensor is at least partly obstructed or impaired by at least one of moisture and the plurality of particles, trigger the one or more nozzles to spray the compressed air on the exterior surface of the optical sensor.

7. The self-cleaning sensor apparatus of claim 1, wherein the nozzle manifold is configured to rotate about the exterior surface of the optical sensor without contacting the exterior surface of the optical sensor.

8. The self-cleaning sensor apparatus of claim 1, wherein the optical sensor comprises at least one of a cylindrical sensor and a Light Detection and Ranging (LiDAR) sensor.

9. The self-cleaning sensor apparatus of claim 1, wherein the actuator system further comprises a first gear rotatably coupled to the motor and a second gear in contact with the first gear, wherein the second gear is configured to rotate in response to rotation of the first gear, wherein the rotary joint is coupled to the second gear and configured to rotate with the second gear, the self-cleaning sensor apparatus further comprising a counterweight directly or indirectly coupled to the nozzle manifold, the counterweight providing a first weight to counter a second weight of the nozzle manifold.

10. An autonomous vehicle comprising:
a mechanical system;
an internal computing system; and
a self-cleaning sensor apparatus comprising:
an optical sensor;
an actuator system comprising a motor configured to rotate a rotary joint of a self-cleaning sensor apparatus;
a nozzle manifold directly or indirectly coupled to the rotary joint, wherein the nozzle manifold is configured to rotate in response to a rotation of the rotary joint, and wherein the nozzle manifold is disposed at an angle relative to a top or bottom surface of the optical sensor; and
one or more nozzles disposed within the nozzle manifold, the one or more nozzles being configured to spray compressed air on an exterior surface of the optical sensor, the exterior surface comprising at least one of a surface of a lens associated with the optical sensor and a surface configured to send and receive optical signals associated with the optical sensor.

11. The autonomous vehicle of claim 10, further comprising a spindle configured to rotate the optical sensor, wherein the actuator system is configured to rotate the nozzle manifold via the rotary joint at a same or substantially similar rotational speed as the optical sensor.

12. The autonomous vehicle of claim 10, further comprising a ring device comprising one or more additional nozzles associated with one or more hoses configured to provide a cleaning liquid to the one or more additional nozzles, wherein the one or more additional nozzles are configured to spray the exterior surface of the optical sensor with the cleaning liquid from the one or more hoses.

13. The autonomous vehicle of claim 12, further comprising a controller device configured to:
trigger the one or more additional nozzles to spray the cleaning liquid on the exterior surface of the optical sensor; and
after triggering the one or more additional nozzles to spray the cleaning liquid on the exterior surface of the optical sensor, trigger the one or more nozzles disposed within the nozzle manifold to spray the compressed air on the exterior surface of the optical sensor.

14. The autonomous vehicle of claim 13, further comprising a controller device configured to:
determine, based on data from the optical sensor, that at least a portion of a field-of-view (FOV) or visibility of the optical sensor is at least partly obstructed or impaired by at least one of moisture and a plurality of particles; and
in response to determining that at least the portion of the FOV or visibility of the optical sensor is at least partly obstructed or impaired by at least one of moisture and the plurality of particles, trigger the one or more additional nozzles to spray the cleaning liquid on the exterior surface of the optical sensor.

15. The autonomous vehicle of claim 10, further comprising a controller device configured to:
determine, based on data from the optical sensor, that at least a portion of a field-of-view (FOV) or visibility of the optical sensor is at least partly obstructed or impaired by at least one of moisture and a plurality of particles; and
in response to determining that at least the portion of the FOV or visibility of the optical sensor is at least partly obstructed or impaired by at least one of moisture and the plurality of particles, trigger the one or more nozzles to spray the compressed air on the exterior surface of the optical sensor.

16. The autonomous vehicle of claim 10, wherein the nozzle manifold is configured to rotate about to the exterior surface of the optical sensor without contacting the exterior surface of the optical sensor.

17. The autonomous vehicle of claim 10, wherein the optical sensor comprises at least one of a cylindrical sensor and a Light Detection and Ranging (LiDAR) sensor.

18. The autonomous vehicle of claim 10, wherein the actuator system further comprises a first gear rotatably coupled to the motor and a second gear in contact with the first gear, wherein the second gear is configured to rotate in response to rotation of the first gear, wherein the rotary joint is coupled to the second gear and configured to rotate with the second gear, the autonomous vehicle further comprising a counterweight directly or indirectly coupled to the nozzle manifold, the counterweight providing a first weight to counter a second weight of the nozzle manifold.

19. A method comprising:
mounting an optical sensor on a sensor mount;
directly or indirectly coupling a nozzle manifold to a rotary joint, wherein the nozzle manifold is configured to rotate in response to a rotation of the rotary joint, and wherein the nozzle manifold is disposed at an angle relative to a top or bottom surface of the optical sensor; and
disposing one or more nozzles within the nozzle manifold, the one or more nozzles being configured to spray compressed air on an exterior surface of the optical sensor, the exterior surface comprising at least one of a surface of a lens associated with the optical sensor and a surface configured to send and receive optical signals associated with the optical sensor.

20. The method of claim 19, further comprising:
disposing a ring device at a distance below the nozzle manifold and one or more sensing elements of the optical sensor, wherein the ring device comprises one or more additional nozzles associated with one or more hoses configured to provide a cleaning liquid to the one or more additional nozzles, and wherein the one or more additional nozzles are configured to spray the exterior surface of the optical sensor with the one or more cleaning liquids from the one or more hoses;
coupling a spindle to the optical sensor, wherein the spindle is configured to rotate the optical sensor; and
coupling an actuator system to the rotary joint, wherein the actuator system is configured to rotate the nozzle manifold via the rotary joint at a same or substantially similar rotational speed as the optical sensor.
